(19) United States
(12) Patent Application Publication
(10) Pub. No.: US 2019/0352963 A1
(43) Pub. Date: Nov. 21, 2019

(54) BLIND APPARATUS

(71) Applicant: WINTEC KOREA INC., Geangiu-si, Gyeonggi-do (KR)

(72) Inventor: Seong-ryong JANG, Seoul (KR)

(21) Appl. No.: 16/476,973

(22) PCT Filed: Jan. 8, 2018
(86) PCT No.: PCT/KR2018/000374

§ 371 Date: Jul. 10, 2019

(30) Foreign Application Priority Data
Jan. 10, 2017 (KR) 10-2017-0003837

(51) Int. Cl. E06B 9/42; E06B 9/80

(52) U.S. Cl. CPC E06B 9/42; E06B 2009/405; E06B 9/80

(57) ABSTRACT

A blind apparatus is provided. The blind apparatus includes: a plurality of rolls respectively coupled to rotary shafts that are parallel with each other; a plurality of screens respectively wound on or unwound from the rolls; and a plurality of weights respectively connected to the lower ends of the screens and applying torque in a first direction in which the screens are unwound to the rolls using gravity, in which the weights are combined with each other by magnetic force.

### TECHNICAL FIELD

The present invention relates to a blind apparatus and, more particularly, to a blind apparatus that can be conveniently operated.

### BACKGROUND ART

A blind apparatus is installed to block direct sunlight passing through a window or gaze from the outside. It is possible to make a more comfortable indoor mood from soft glow effect by appropriately adjusting the amount of light using a blind apparatus. A blind apparatus is installed over a window and has a structure that can be opened/closed.

A blind apparatus may include a screen that is rolled and unrolled. It is possible to open a portion or the entire of a window and adjust the amount of light by adjusting the size of the screen. In such a roll type blind apparatus, it is possible to adjust the size of the screen using a cord that rotates the roll.

That is, existing blind apparatuses are formed such that a user can easily rotate a roll over a window by pulling down a cord and transmitting tension. However, according to this structure, force is concentrated on the side connected with the cord, so there is a problem that the blind apparatus becomes unbalanced or the joint between the roll and the cord is easily broken when it is used for a long period of time.

Further, when a cord is hung down too long, people, particularly, careless children easily trip on it, so there is a high possibility of a safety accident. Further, it is required to rotate the entire roll with the balance maintained with a cord connected to a side of the roll, so the rotation structure is unnecessarily complicated and there are many other problems.

### CITATION LIST

### Patent Literature

(Patent Literature 1) Korean Utility Model No. 20-0480955 (2016.07.29)

### DISCLOSURE OF INVENTION

### Technical Problem

The present invention has been made in an effort to solve the problems, and an object of the present invention is to provide a blind apparatus that can be conveniently operated.

The object of the present invention is not limited to those described above and other objects may be made apparent to those skilled in the art from the following description.

### Solution to Problem

A blind apparatus according to the present invention includes: a plurality of rolls respectively coupled to rotary shafts that are parallel with each other; a plurality of screens respectively wound on or unwound from the rolls; and a plurality of weights respectively connected to the lower ends of the screens and applying torque in a first direction in which the screens are unwound to the rolls using gravity, in which the weights are combined with each other by magnetic force.

The blind apparatus may further include: a plurality of elastic members applying torque in a second direction in which the screens are wound by respectively applying elasticity to the rolls; and a friction stopper assembly generating friction force on the rolls, respectively.

The friction force may offset the resultant force of the torque applied to the rolls in the first direction and the torque applied to the rolls in the second direction.

The rotary shafts may include a first rotary shaft extending in the rolls, and the friction stopper assembly may include a first rotary block coupled to the rolls to rotate with the rolls and generating friction on the first rotary shaft.

The first rotary shaft may have threads on the outer side to be a male screw, and the first rotary block may have threads on the inner side of a hole formed through the center thereof to be a female screw that is thread-fastened to the male screw.

The blind apparatus may further include a friction member that is disposed on at least one of the outer side of the first rotary shaft and the inner side of the first rotary block to increase friction resistance.

The friction member may extend in the longitudinal direction of the first rotary shaft, on the outer side of the first rotary shaft.

The plurality of weights may include magnets extending in parallel with each other along the lower ends of the screens and arranged such that different poles face each other.

The magnets may be disposed at both ends of the weights.

The contact surfaces of the plurality of weights may be flat surfaces.

At least one of the magnets may be disposed on the flat surface.

### Advantageous Effects of Invention

According to the present invention, it is possible to very conveniently operate a blind apparatus. According to the blind apparatus of the present invention, it is possible to very easily adjust the length of a screen by winding or unwinding it even without a cord, and it is also possible to stably maintain the adjusted length. Accordingly, it is possible to effectively solve the problem that a blind apparatus is unbalanced or the joint of a cord is broken due to repeated use. Further, it is possible to improve the aesthetic appearance of a blind apparatus by simplifying the external appearance of the blind apparatus, and it is also possible to prevent a safety accident that a person trips on a long cord. Therefore, the blind apparatus can provide various effects.

### BRIEF DESCRIPTION OF DRAWINGS

FIG. 1 is a perspective view showing a blind apparatus according to an embodiment of the present invention.

FIG. 2 is an exploded perspective view of a roll of the blind apparatus shown in FIG. 1.

FIG. 3 is a cross-sectional view showing the inside of the roll of the blind apparatus shown in FIG. 1.

FIG. 4 is a perspective view enlarging a first rotary shaft and a friction stopper assembly of the blind apparatus shown in FIG. 1.

FIG. 5 is an exploded perspective view of the first rotary shaft and the friction stopper assembly shown in FIG. 4.

FIG. 6 is a cross-sectional view of the first rotary shaft and the friction stopper assembly shown in FIG. 4.

FIG. 7 is a perspective view showing a modification of the friction stopper assembly.

FIG. 8 is a partial enlarged view showing an example of applying the friction stopper assembly shown in FIG. 7.

FIGS. 9 and 10 are views showing the operation of the blind apparatus shown in FIG. 1.

FIG. 11 is a perspective view showing blind apparatuses according to other embodiments of the present invention in different directions.

FIG. 12 is a cross-sectional view showing a weight and a coupling ring of the blind apparatus shown in FIG. 11.

FIGS. 13 and 14 are views showing the operation of the blind apparatus shown in

FIG. 11.

FIG. 15 is a perspective view showing a blind apparatus according to another embodiment of the present invention.

FIG. 16 is a side view of the blind apparatus shown in FIG. 15.

### MODE FOR THE INVENTION

The advantages and features of the present invention and methods of achieving them will be clear by referring to the exemplary embodiments that will be described hereafter in detail with reference to the accompanying drawings. However, the present invention is not limited to the exemplary embodiments described hereafter and may be implemented in various ways, and the exemplary embodiments are provided to complete the description of the present invention and let those skilled in the art completely know the scope of the present invention and the present invention is defined by claims. Like reference numerals indicate the same components throughout the specification.

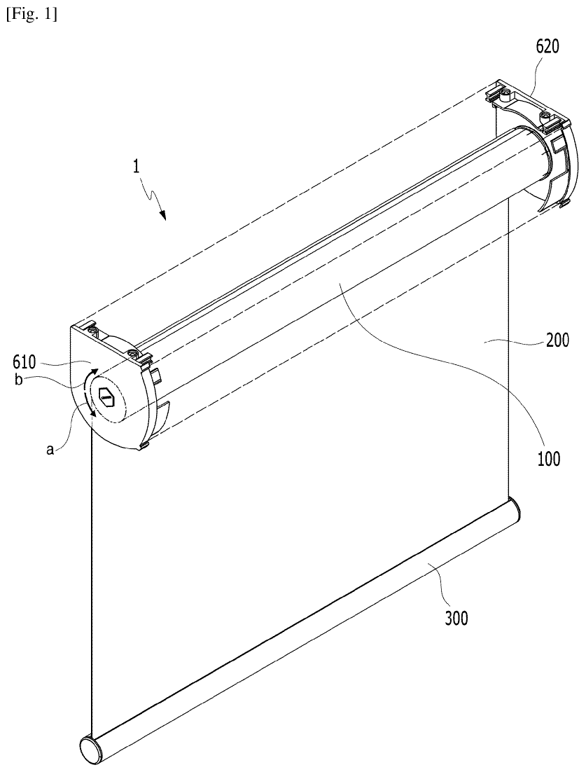

Hereinafter, a blind apparatus according to an embodiment of the present invention is described in detail with reference to FIGS. 1 to 10.

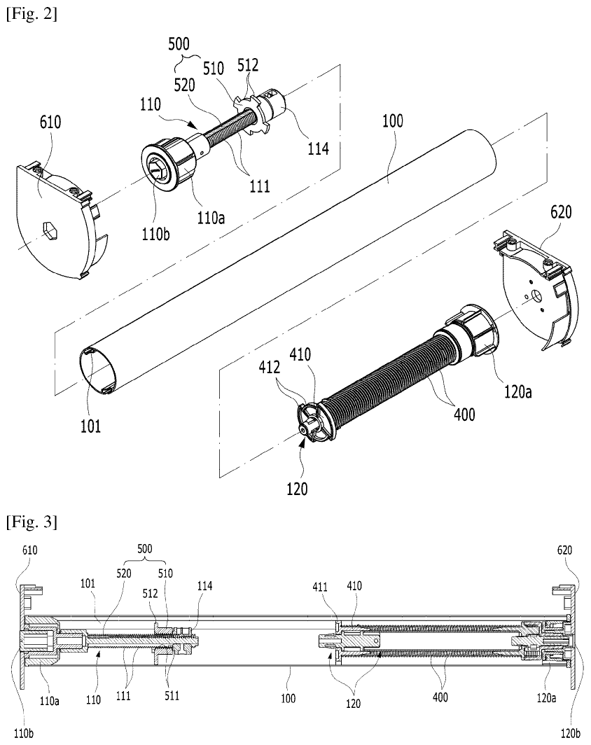

FIG. 1 is a perspective view showing a blind apparatus according to an embodiment of the present invention, FIG. 2 is an exploded perspective view of a roll of the blind apparatus shown in FIG. 1, and FIG. 3 is a cross-sectional view showing the inside of the roll of the blind apparatus shown in FIG. 1.

Referring to FIGS. 1 to 3, a blind apparatus 1 according to an embodiment of the present invention includes: a roll 100 that is coupled to a rotary shaft; a screen 200 that is wound or unwound on the roll 100; a weight 300 that is connected to the lower end of the screen 200 and applies torque to the roll 100 by gravity in a first direction (see ‘a’ in FIG. 1) in which the screen 100 is unwound; an elastic member 400 (see FIGS. 2 and 3) that applies torque in a second direction (see ‘b’ in FIG. 1) in which the screen 200 is wound by applying elasticity to the roll 100; and a friction stopper assembly 500 (see FIGS. 2 and 3) that generates friction on the roll 100. The blind apparatus 1, as shown in the figures, has a structure with a cord completely removed, so it has a very simple external shape.

The blind apparatus 1 is easily operated even without a cord by torques that are applied to the roll 100 in opposite directions. The torques are increased or decreased in balance, depending on the unwound length of the screen 200. Since the torques balance with each other, but act in opposite direction, it is possible to easily break the balance by applying minimum external force (which can be easily transmitted by touching the screen or the weight) and easily restore the balance by removing the external force. Accordingly, it is possible to rotate the roll 100 by applying external force in a desired direction or stop the roll 100 at the rotated position by removing the external force.

Further, there may be a subtle difference between the magnitudes of torques due to reasons related to structure, design, and manufacturing process, but it is possible to solve this problem by generating friction force using the friction stopper assembly 500. It is possible to more easily maintain a stop status by removing the resultant force of opposite torques with friction force. Further, since appropriate resistance is applied by the friction force generated by the friction stopper assembly 500, it is possible to prevent undesired rotation of the roll 100 and easily keep the roll 100 stopped until appropriate external force is transmitted. As described above, by using the pair of opposite torques and friction force, it is possible to very conveniently operate the blind apparatus even without a cord.

The blind apparatus 1 having these characteristics is described hereafter in more detail with reference to the drawings. Other characteristics of the present invention will be clearly known through the following description.

The roll 100 is formed in a cylindrical shape. The roll 100 may be formed in the hollow cylindrical shape, as shown in FIGS. 1 to 3. The roll 100 may be disposed between fixing brackets 610 and 620 to which a rotary shaft is fixed, and the fixing brackets 610 and 620 may be combined with a housing (indicated by dotted lines in FIG. 1) that keeps the roll 100 therein. Since the roll 100 is hollow, the rotary shaft can be inserted in the roll 100. Further, the elastic member 400 and the friction stopper assembly 500 can also be inserted in the roll 100. However, the roll 100 is not necessarily limited to a cylindrical shape and at least a portion of the roll 100 may be changed in an appropriate shape easy to wind or unwind the screen 200. The roll 100 can be fitted and rotated on rotary shafts (a first rotary shaft and a second rotary shaft).

The roll 100 may be coupled to one or more rotary shafts. As in an embodiment of the present invention, a first rotary shaft 110 and a second rotary shaft 120 may be coupled to both ends of the roll 100. By preparing separate rotary shafts and coupling them to different ends, it is possible to more efficiently use the internal space of the roll 100. However, the present invention is not limited thereto and a single rotary shaft may be fitted in the roll 100. A structure having the first rotary shaft 110 and the second rotary shaft 120 is exemplified in the following description of an embodiment of the present invention.

The screen 200 is wound or unwound on the roll 100. The screen 200 can be wound on the roll 100 or unwound from the roll 100 when the roll 100 is rotated. An end of the screen 200 may be connected to the roll 100 to rotate with the roll 100 and the other end may be connected and fixed to a weight 300. Assuming that the screen 200 is unwound when the roll 100 is rotated in a predetermined direction, the screen 200 can be wound when the roll 100 is rotated in the opposite direction. The screen 200 may be made of fabric, but is not limited thereto. The screen 200 may be made of various flexible materials.

The weight 300 is connected to the lower end of the screen 200. As shown in FIG. 1, as the weight 300 is connected to the lower end of the screen 200, the screen 200 can be unrolled. The weight 300 has appropriate mass, so it transmits tension due to gravity to the screen 200, and the tension transmitted to the screen 200 can act as torque that rotates the roll 100. That is, the weight 300 is connected to the lower end of the screen 200, and it applies torque to the roll 100 in a first direction in which the screen 200 is unwound by gravity. The weight 300 may be formed in a bar shape having a length corresponding to the width of the screen 200, but it may be formed in other various shapes.

The elastic member 400 applies torque in a second direction in which the screen 200 is wound, by applying elasticity to the roll 100. The elastic member 400 may be disposed in the roll 100, as shown in FIG. 2. That is, since the elastic member 400 is provided, torque is applied to the roll 100 in the opposite direction to the first direction in which the weight 300 applies torque, so the roll 100 can be balanced. The elastic member 400 may be a torsional elastic body that keeps elastic energy by elastically deforming with rotation of the roll 100 and the torsional elastic body may be a coil spring fitted on the outer side of the rotary shaft. For example, as shown in FIG. 2, the elastic member 400 that is a torsional elastic body may be a coil spring fitted on the outer side of the second rotary shaft 120.

The more the roll 100 is rotated, the larger the deformation of the elastic member 400 and the larger the restoring force accordingly. The restoring force acts in the opposite direction to the rotation causing the deformation, so it generates opposite torque. For example, when the screen 200 is unwound, as the roll 100 is rotated in the unwinding direction, the torque in the opposite direction, that is, a winding direction (the second direction) is increased by elasticity. Further, since the length of the screen 200 increases when the screen 200 is unwound, the torque in the unwinding direction (the first direction) due to gravity is also increased by the sum of the weights of the weight 300 and the screen 200. Accordingly, the first-directional torque and the second-directional torque are increased in balance. By the balance of torques, it is possible to simply rotate the roll 100 and easily stop the roll 100 at a rotated position. Detailed operation will be described in more detail below.

The elastic member 400 is disposed between the second rotary shaft 120 and the roll 100 and can generate torque. The elastic member 400, for example, may be coupled to the roll 100 through a rotary block that is coupled to the roll 100 to rotate. As described above, the second rotary shaft 120 extends in the roll 100 and a second rotary block 410 that is coupled to the roll 100 to rotate with the roll 100 may be formed in the roll 100. Both ends of the elastic member 400, as shown in FIGS. 2 and 3, may be connected and fixed to the second rotary block 410 and the second rotary shaft 120, respectively. The second rotary shaft 120 may pass through the rotational center of the second rotary block 410 and a holder 412 formed around the outer side of the second rotary block 410 are fitted on guide rails 101 (see FIGS. 1 to 3) on the inner side of the roll 100, so the roll 100 and the second rotary block 410 can be rotated together.

According to this structure, when the roll 100 is rotated, the second rotary block 410 is also rotated and the end of the elastic member 400, which is connected to the second rotary block 410, can be twisted and deformed. The second rotary shaft 120 rotatably supports the roll 100, but does not rotate itself, so a second end of the elastic member 400, which is fixed to the second rotary shaft 120, is maintained fixed. Accordingly, torsion is generated between the first end and the second end of the elastic member 400, whereby elastic energy is kept. The elastic member 400 can be configured in this way. However, the configuration of the torsion spring 400 is not limited thereto and the elastic member 400 may be configured in other ways that can generate torque by applying elasticity to the roll 100.

The second rotary shaft 120 and the first rotary shaft 110 may be fixed to the fixing brackets 610 and 620, respectively. Fixing portions 110b and 120b may be formed in various shapes at the ends, which face the fixing brackets 610 and 620, of the first rotary shaft 110 and the second rotary shaft 120 to firmly fix the rotary shafts. For example, the fixing portions 110b and 120b may be formed in various ways such as a fitting structure using a projection and a hole or a thread-fastening structure. Further, rotary rings 110a and 120a may be rotatably fitted on the first rotary shaft 110 and the second rotary shaft 120, respectively, and as shown in FIG. 3, the rotary rings 110a and 120a may be coupled to both ends of the roll 100. Accordingly, the roll 100 is supported by the rotary rings 110a and 120a, so it can be rotated on the rotary shafts.

The friction stopper assembly 500 includes a first rotary block 510 combined with the roll 100 to be rotated with the roll 100 and generating friction on the first rotary shaft 110. The first rotary shaft 110 also extends in the roll 100 and the first rotary block 510 is disposed in the roll 100 to rotate with the roll 100. The first rotary shaft 110 may pass through the rotational center of the first rotary block 510 and holders 512 are formed around the outer side of the first rotary block 510, as shown in FIGS. 2 and 3, so the first rotary block 510 can be fitted on the guide rails 101 in the roll 100. Accordingly, the roll 100 and the first rotary block 510 are rotated together. Further, the second rotary block 410 has the same structure, so it can be rotated with the roll 100.

The holders 412 and 512 of the first rotary block 510 and the second rotary block 410 can be slidably fitted on the guide rails 101 in the roll 100. Accordingly, the first rotary block 510 and the second rotary block 410 can rotate with the roll 100 and can horizontally move. As shown in FIGS. 1 to 3, the guide rails 101 extend in parallel with the first rotary shaft 110 and the second rotary shaft 120 and can guide the blocks sliding in parallel with the rotary shafts. Accordingly, the first rotary block 510 can horizontally move in the longitudinal direction of the first rotary shaft 110 while rotating, and the second rotary block 410 can also horizontally move in the longitudinal direction of the second rotary shaft 120 while rotating. Accordingly, since the rotary blocks horizontally move while rotating, they can more easily cause friction, so it is possible to more flexibly cope with elastic deformation.

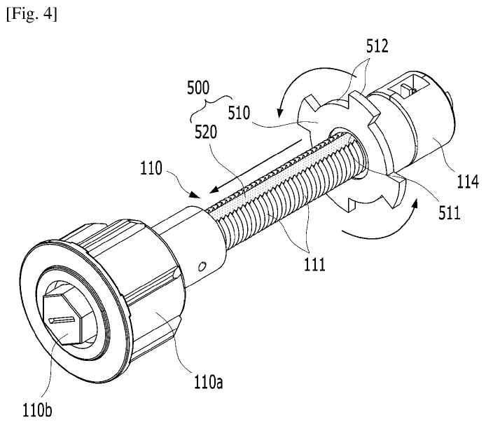

The friction stopper assembly 500 can more effectively provide friction force to the roll 100 through thread-fastening or contact of a friction member 520. A combination of thread-fastening and the friction member 520 is exemplified in an embodiment of the present invention to be described below. However, it may be possible to apply only thread-fastening or the friction member 520 to the friction stopper assembly 500 in other embodiments. The friction stopper assembly 500 is described hereafter in more detail with reference to FIGS. 4 to 8.

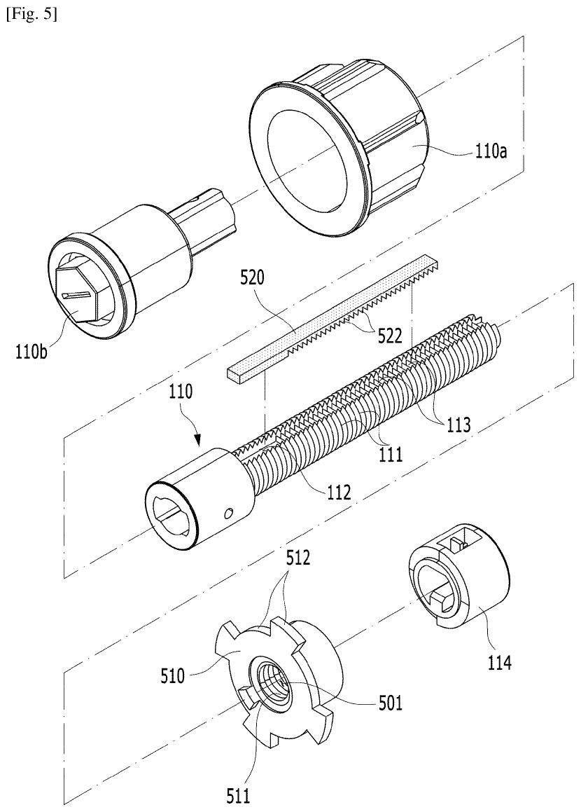

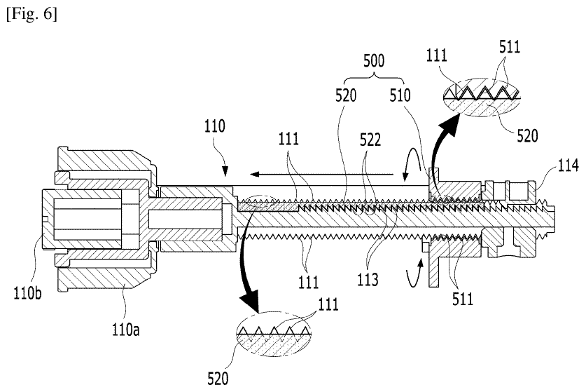

FIG. 4 is a perspective view enlarging the first rotary shaft and the friction stopper assembly of the blind apparatus shown in FIG. 1, FIG. 5 is an exploded perspective view of the first rotary shaft and the friction stopper assembly shown in FIG. 4, and FIG. 6 is a cross-sectional view of the first rotary shaft and the friction stopper assembly shown in FIG. 4.

The friction stopper assembly 500 is formed in the shape shown in FIGS. 4 to 6. The friction stopper assembly 500 may be formed on the first rotary shaft 110, and as described above, it can generate friction through the first rotary block 510 coupled to the roll 100 (see FIGS. 1 to 3) and rotating with the roll 100. The holders 512 are formed around the outer side of the first rotary block 510, so the first rotary block 510 can be combined with the roll 100, as described above. The holder 512 may have a structure such as a groove or a projection, and for example, grooves may be slidably fitted on the guide rails 101 (see FIGS. 1 to 3) of the roll 100. Accordingly, the first rotary block 510 can horizontally move in the longitudinal direction of the first rotary shaft 110 while rotating, as shown in FIGS. 4 and 6.

The first rotary shaft 110 has threads 111 on the outer side, as shown in FIGS. 4 to 6. The first rotary shaft 110 can be disassembled, and as shown in FIG. 5, the fixing portions 110b and 120b at an end and a stopper 114 at the other end can be combined or separated. Accordingly, the rotary ring 110a can be separated and combined and the first rotary block 510 can also be easily combined. The stopper 114 can set a limit so that the first rotary block 510 cannot horizontally move more than a predetermined distance by limiting the movement path of the first rotary block 510. The stopper 114 may be detachable, and if necessary, the position of the stopper 114 may be changed.

Threads 511 are formed on the inner side of a hole at the center of the first rotary block 510. The threads 511 may be formed in the inner side of a hole 501 at the center of the first rotary block 510. The threads 111 on the outer side of the first rotary shaft 110 may be male threads and the threads 511 on the inner side of the first rotary block 510 may be female threads that are fitted on the male threads. That is, the first rotary block 510 and the first rotary shaft 110 are engaged with each other through the threads 111 and 511 and generate friction by rotating. In particular, the first rotary block 510 is not simply rotated, but rotated by the threads 111 and 511, and it moves perpendicular to the rotational direction (see FIGS. 4 and 6). Accordingly, the first rotary block 510 can more effectively generate friction by moving along the threads 111 and 511.

The friction member 520 may be disposed on at least one of the outer side of the first rotary shaft 110 and the inner side of the first rotary block 510. It is exemplified in an embodiment of the present invention to be described below that the friction member 520 is disposed on the outer side of the first rotary shaft 110. However, in other embodiments, the friction member may be disposed on the inner side of the first rotary block 510 or on both of the outer side of the first rotary shaft 110 and the inner side of the first rotary block 510. When the friction member 520 is disposed on the first rotary shaft 110, as in an embodiment of the present invention, it is possible to more actively use the friction member 520 using the space of the first rotary shaft 110. The friction member 520 is described in more detail hereafter.

The friction member 520, as shown in FIGS. 4 to 6, may be disposed on the outer side of the first rotary shaft 110 and extend in the longitudinal direction of the first rotary shaft 110. Accordingly, as shown in FIGS. 4 and 6, while the first rotary block 510 rotates and moves, the friction member 520 can more effectively generate friction in contact with the threads 511 of the first rotary block 510. That is, the friction member 520 extends in the longitudinal direction of the first rotary shaft 110 and is brought in contact with the first rotary block 510 moving in the longitudinal direction of the first rotary shaft 110, so it can generate friction, depending on a change in position of the first rotary block 510.

The friction member 520, as shown in FIG. 5, may be inserted in a long groove 112 formed on the outer side of the first rotary shaft 110. The long groove 112 may be formed across the threads 111. Fixing projections 113 and 522 that are fitted to each other are formed on the contact surfaces of the long groove 112 and the friction member 520, so the friction member 520 can be effectively fixed at the position. The friction member 520 may be formed in a bar shape that is easily inserted in the long groove 112, and the thickness can be appropriately changed to generate appropriate friction. The contact surface, which faces the first rotary block 510, of the friction member 520 may be maintained at the height shown in FIG. 6.

As shown in FIG. 6, the contact surface, which faces the first rotary block 510, of the friction member 520 may extend between the ridges and grooves of the threads 111 of the first rotary shaft 110 (see the enlarged view in FIG. 6). Accordingly, at least some of the threads 511 of the first rotary block 510 can generate appropriate friction by pressing the surface of the friction member 520. The portion, which is in contact with the first rotary block 510, of the friction member 520 can keep in contact by elastically deforming (see the enlarged view in FIG. 6). Accordingly, friction force can be more effectively generated and transmitted to the roll 100 (see FIGS. 1 to 3).

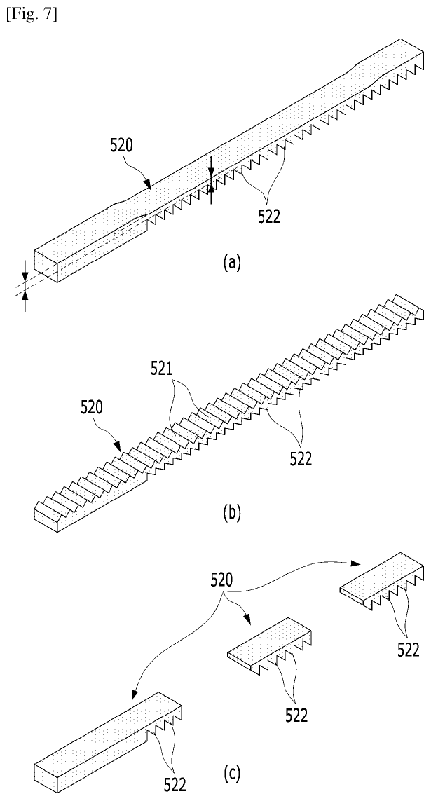

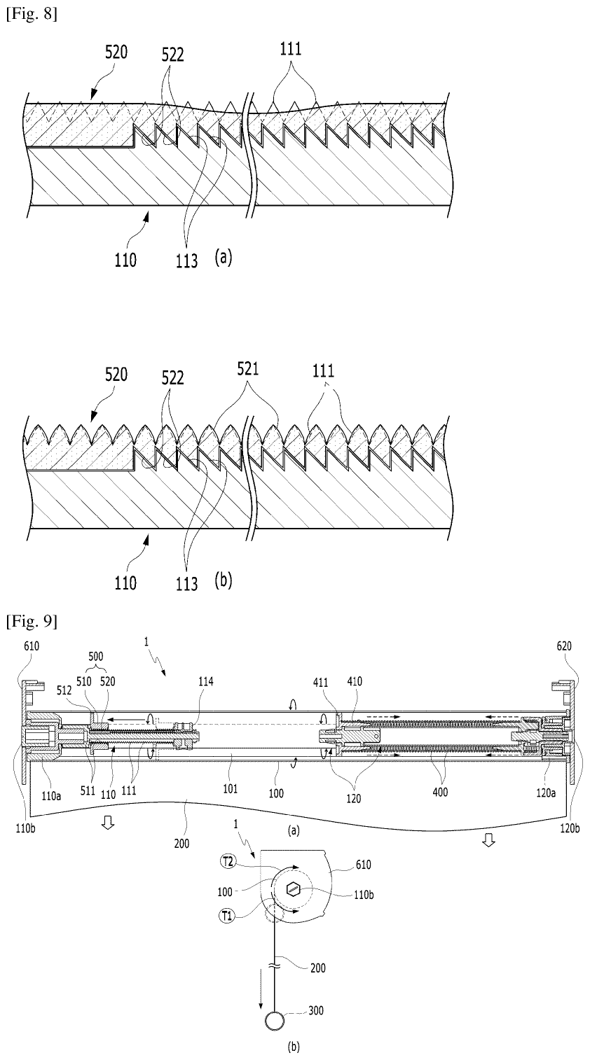

On the other hand, at least a portion of the friction member 520 may be appropriately modified. The friction member 520 may be appropriately modified so that friction is increased or decreased at a specific position on the friction member 520. The friction member 520 may be formed such that friction resistance is changed in the longitudinal direction of the first rotary shaft 110, and accordingly, the first rotary block 510 can generate different intensities of friction at different positions while moving in the longitudinal direction of the first rotary shaft 110. A modification of the friction member 520 is described hereafter in more detail with reference to FIGS. 7 and 8.

FIG. 7 is a perspective view showing a modification of the friction stopper assembly and FIG. 8 is a partial enlarged view showing an example of applying the friction stopper assembly shown in FIG. 7.

For example, the friction member 520 may be modified, as shown in FIG. 7. The friction member 520 is an elastic body that is elastically deformed between the first rotary shaft 110 (see FIGS. 4 to 6) and the first rotary block 510 (see FIGS. 4 to 6) and the thickness or the area of the friction member 520 may be changed in the longitudinal direction of the first rotary shaft 110. As shown in (a) of FIG. 7, the thickness of the friction member 520 may be changed to increase friction at a specific position. Accordingly, it is possible to relatively increase friction force at a position where the first-directional torque and the second-directional torque do not balance with each other.

That is, when the roll 100 (see FIGS. 1 to 3) is rotated and the screen 200 (see FIGS. 1 to 3) is fully wound or the roll 100 is rotated in the opposite direction and the screen 200 is fully unwound, balance between the first-directional torque and the second-directional torque may be unexpectedly broken due to insufficient or excessive restoring force of the elastic member 400. In this case, it may be very difficult to keep the roll 100 at the rotated position. Accordingly, by providing friction force at this position, it is possible to stop the roll 100 by more effectively offsetting the resultant force of the first-directional torque and the second-directional torque.

For example, as shown in (a) of FIG. 7, when the thicknesses of both end portions of the friction member 520 is increased, as shown in (a) of FIG. 8, the contact surface, which faces the first rotary block 510 (see FIGS. 4 to 6), of the friction member 520 is relatively increased in height at the portions. Accordingly, the friction between the contact surface and the first rotary block 510 is increased. Both end portions of the friction member 520 stops the first rotary block 510 and also stops rotation of the roll 100, so the roll 100 can be positioned to correspond to the fully wound or unwound position of the screen 200. The roll 100 can be more effectively maintained stopped by increasing friction at such specific positions.

Further, as shown in (b) of FIG. 7, serrations 521 may be formed on the surface, which is in contact with the first rotary block 510 (see FIGS. 4 to 6), of the friction member 520. As described above, when the friction member is disposed on the first rotary block 510, the serrations 521 may be formed on the surface that is in contact with the first rotary shaft 110 (see FIGS. 4 to 6) of the friction member. The serrations 521, for example, may be arranged to correspond to the threads 111 of the first rotary shaft 110, and as shown in (b) of FIG. 8, they may be formed wider than the threads 111 to generate friction. As described above, since the serrations 521 are formed on the friction member 520, appropriate friction force can be generated and transmitted to the roll 100 (see FIGS. 1 to 3).

It can also be possible to increase friction force at specific positions by appropriately modifying the serrations 521. It is possible to increase or decrease friction by changing at least one of the height, gap, and shape of the serrations 521 in the longitudinal direction of the first rotary shaft 110, that is, the extension direction of the friction member 520 in FIGS. 7 and 8. For example, as described above, it is possible to increase friction force at the corresponding positions by increasing the height, decreasing the gap, or increasing the width of the serrations 521 at both end portions of the friction member 520.

Not one, but a plurality of friction members 520 may be arranged at different positions. As shown in (c) of FIG. 7, it is possible to additionally provide the friction members 520 only at positions where friction needs to be increased. For example, one or more friction members 520 may be separately inserted at different positions in the long groove 112 (see FIG. 5). In this case, the friction members 520 can be easily fixed by the fixing projections 522 of the friction members 520. As described above, by appropriately modifying the friction member 520 in various shapes, it is possible to more effectively provide friction force to the roll 100.

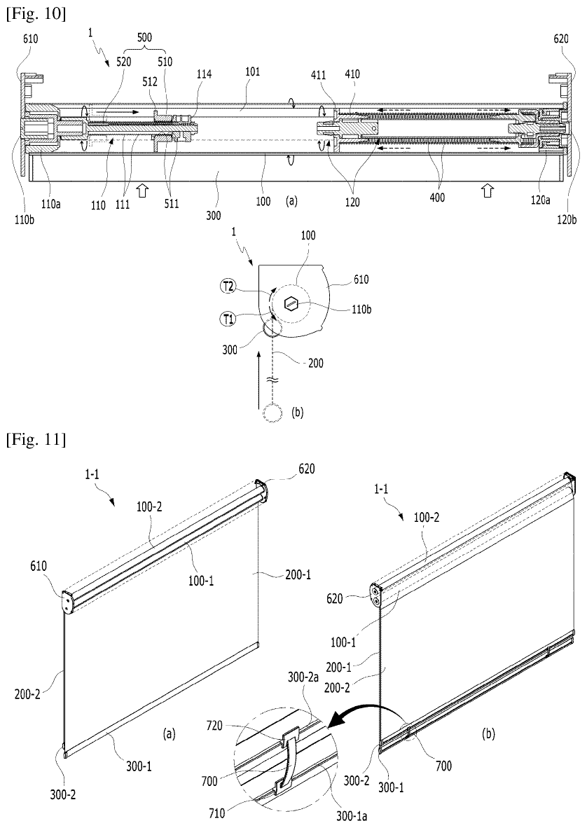

Hereinafter, the operation of blind apparatus is described in more detail with reference to FIGS. 9 and 10.

FIGS. 9 and 10 are views showing the operation of the blind apparatus shown in FIG. 1.

The blind apparatus 1 can be very easily operated even without a cord because the structural characteristics described above. The weight 300 applies the first-directional torque T1 (see FIGS. 9 and 10) to the roll 100 in which the screen 200 is unwound, while the elastic member 400 applies the second-directional torque T2 (see FIGS. 9 and 10) in which the screen 200 is wound. Accordingly, it is possible to keep the balance of the roll 100 at various rotating positions and to easily keep the roll 100 stopped using the friction force generated by the friction stopper assembly 500.

That is, it is possible to easily break the balance and adjust the length of the screen 200 by applying a minimum external force to the blind apparatus 1 (by simply touching the screen or the weight), using the torques T1 and T2 that are increased or decreased and applied in opposite directions, depending on the unwound length of the screen 200. Further, it is possible to maintain the screen 200 at the length by returning to the balanced state by removing the external force. Even if subtle unbalance is generated between the torques T1 and T2, the resultant force of the opposite torques T1 and T2 is offset by friction forces, so the stopped state can be more easily maintained.

For example, the screen 200 can be unwound, as shown in (b) of FIG. 9. In this case, as the roll 100 is rotated, as shown in (a) of FIG. 9, the second rotary block 410 combined with the roll 100 is also rotated. Accordingly, the elastic member 400 connected to the second rotary block 410 is deformed, and elastic energy is kept. The elastic member 400 deforms to correspond to the unwound length of the screen 200, whereby the restoring force is increased. The restoring force acts as the first-directional torque T1, as shown in (b) of FIG. 9.

Further, the second-directional torque T2 is also increased. The load as much as the unwound length of the screen 200 is added to the load of the weight 300, and the gravitational action is enhanced. Accordingly, the tension in the screen 200 is increased by the gravity and the increased tension acts as the second-directional torque T2. The second-directional torque T2 is generated in the exact opposite direction to the first-directional torque T1, so balance can be maintained. It is possible to adjust the magnitudes of the first-directional torque T1 and the second-directional torque T2 to be the same by adjusting the modulus of elasticity of the elastic member 400 or the load of the weight 300.

As shown in (a) of FIG. 9, the first rotary block 510 generates friction force by moving while rotating on the first rotary shaft 110. The friction force acts on the roll 100, thereby keeping the roll 100 stopped. It is possible to more effectively generate friction force, using the structure including the friction member 520 and the thread-fastening between the first rotary block 510 and the first rotary shaft 110. Even if there is a subtle difference between the first-directional torque T1 and the second-directional torque T2, the friction force on the roll 100 removes the difference, thereby keeping the roll 100 stopped. That is, even if the resultant force of the first-directional torque T1 and the second-directional torque T2 that are applied in opposite directions remains, the resultant force is offset by friction force, whereby the roll can be effectively maintained stopped.

This action is performed in the same principle even when the screen 200 is wound, as shown in FIG. 10. As shown in (b) of FIG. 10, when the screen 200 is wound, the roll 100 is rotated in the opposite direction, as shown in (a) of FIG. 10, the deformation of the elastic member 400 reduces and the original shape is restored, and the kept elastic energy is reduced and the restoring force is also decreased. Accordingly, the first-directional torque T1 is correspondingly reduced. Further, the unwound length of the screen 200 reduces and the gravitational action is made only by the load of the weight 300, so the second-directional torque T2 applied to the roll 100 is correspondingly decreased. Further, since the first rotary block 510 also generates friction force by moving while rotating in the opposite direction, the first-directional torque T1 and the second-directional torque T2 are balanced and the roll 100 can be maintained stopped by the friction force.

That is, regardless of winding or unwinding of the screen 200, the first-directional torque T1 and the second-directional torque T2 is increased or decreased in balance and the friction stopper assembly 500 stops the roll 100 by generating friction force. A user can easily adjust the length of the screen 200 by applying minimum external force that is enough to break the balance, and can maintain a desired length at a desired position by removing the external force. The operation can be very easily achieved only by simply touching up or down the screen 200 or the weight 300 connected to the screen 200. Accordingly, it is possible to obtain a remarkably improved and convenient use environment using the blind apparatus 1 of the present invention.

Hereinafter, a blind apparatus according to another embodiment of the present invention is described in detail with reference to FIGS. 11 to 14. For clear and simple description, differences from the previous embodiment are described and description of the other components not specifically stated is substituted with the above description.

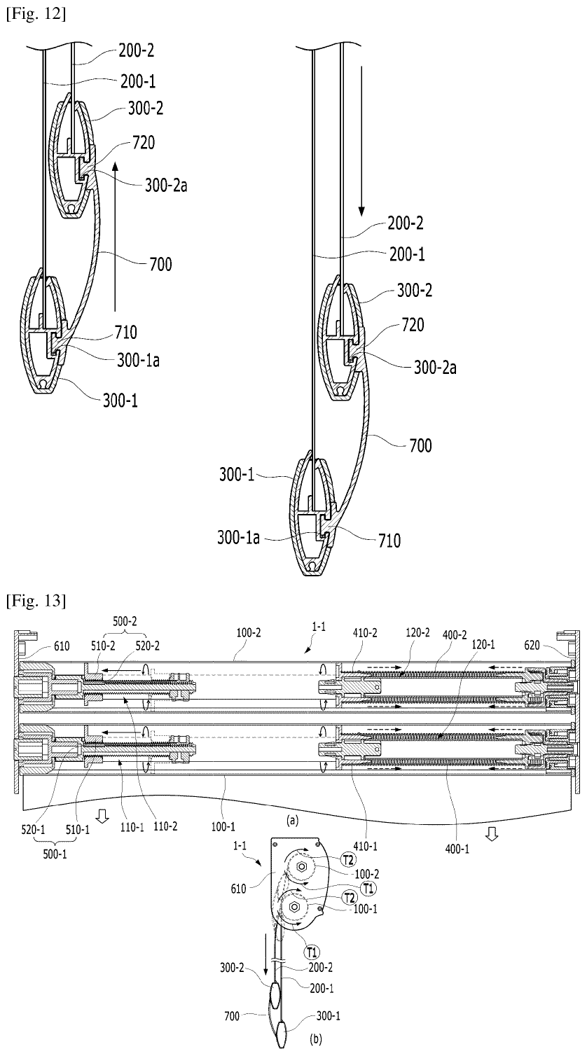

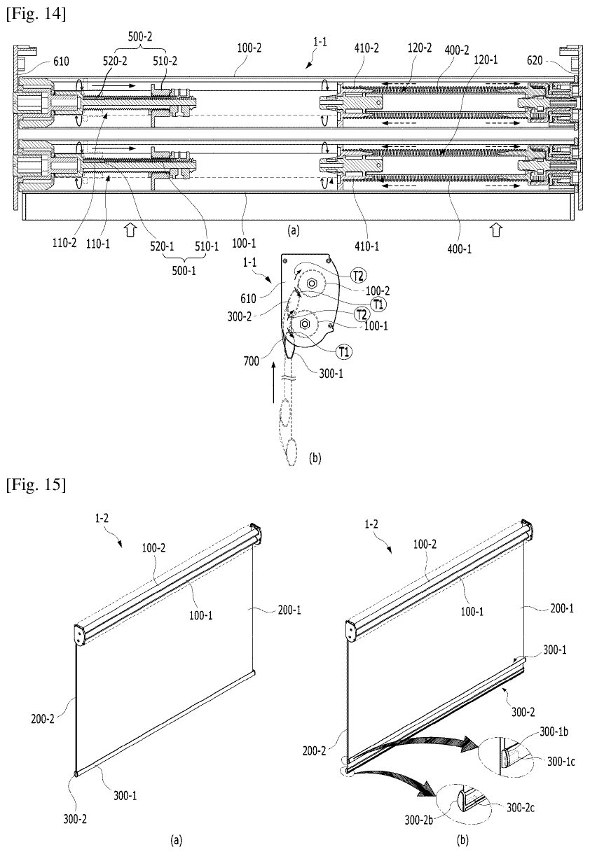

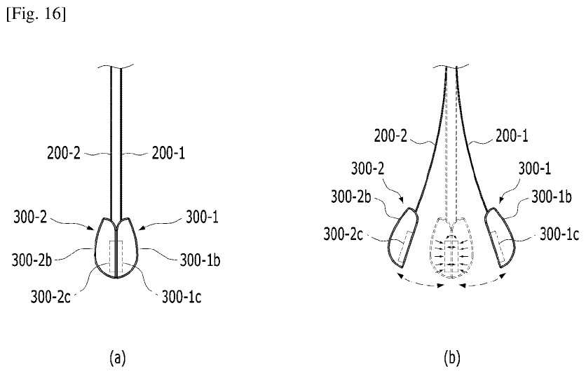

FIG. 11 is a perspective view showing blind apparatuses according to other embodiments of the present invention in different directions, FIG. 12 is a cross-sectional view showing a weight and a coupling ring of the blind apparatus shown in FIG. 11, and FIGS. 13 and 14 are views showing the operation of the blind apparatus shown in FIG. 11.

Referring to FIGS. 11 to 14, a blind apparatus 1-1 according to another embodiment of the present invention includes a plurality of rolls 100-1 and 100-2, and a plurality of screens 200-1 and 200-2, weights 300-1 and 300-2, and elastic members 400-1 and 400-2 (see FIGS. 13 and 14) in correspondence to the rolls 100-1 and 100-2. A plurality of friction stopper assemblies 500-1 and 500-2 (see FIGS. 13 and 14) may be provided to correspond to the roll 100-1 and 100-2, but a friction stopper assembly may be formed on at least only one of the rolls 100-1 and 100-2 if necessary. Using this structure, it is possible to easily operate the plurality of rolls 100-1 and 100-2 and easily adjust the lengths of the screens 200-1 and 200-2 overlapping each other without a cord.

The plurality of rolls 100-1 and 100-2 are arranged in parallel with each other, as shown in FIGS. 11, 13, and 14. Each roll 100-1 and 100-2 may be both rotatably disposed between fixing brackets 610 and 620. The rolls 100-1 and 100-2 may be fitted on rotary shafts, respectively, to rotate and the rotary shafts may be coupled to the fixing brackets 610 and 620. The rotary shafts may include first rotary shafts 110-1 and 110-2 (see FIGS. 13 and 14) and second rotary shafts 120-1 and 120-2 (see FIGS. 13 and 14) that are inserted in both end portions of rolls 100-1 and 100-2, respectively. As shown in FIGS. 13 and 14, different first rotary shafts 110-1 and 110-2 inserted in different rolls 100-1 and 100-2 may be coupled to one fixing bracket 610, and different second rotary shafts 120-1 and 120-2 inserted in different rolls 100-1 and 100-2 may be coupled to the other fixing bracket 620.

The screens 200-1 and 200-2, weights 300-1 and 300-2, elastic members 400-1 and 400-2 are provided to correspond to the rolls 100-1 and 100-2. That is, a plurality of screens 200-1 and 200-2, weights 300-1 and 300-2, elastic members 400-1 and 400-2 can be provided to correspond to the plurality of rolls 100-1 and 100-2. Accordingly, a structure that is substantially the same as the operational structure described in the previous embodiment can be provided in the rolls 100-1 and 100-2, as shown in FIGS. 13 and 14. Accordingly, the rolls 100-1 and 100-2 can wind or unwind corresponding screens 200-1 and 200-2 by rotating, as described above. Detailed description of the operation of the rolls 100-1 and 100-2 refers to the above description.

In particular, the blind apparatus 1-1 according to another embodiment of the present invention includes a coupling ring 700 at least one of between the screens 200-1 and 200-1 or between the weights 300-1 and 300-2. The coupling ring 700 may be provided between the weights 300-1 and 300-2, as shown in (b) of FIG. 11. Accordingly, it is possible to simultaneously operate the rolls 100-1 and 100-2 and more conveniently wind or unwind the screens 200-1 and 200-2. The coupling ring 700 may be slidably fitted in guide grooves 300-1a and 300-2a formed on the weights 300-1 and 300-2, respectively.

The guide grooves 300-1a and 300-2a may be formed in the shapes shown in (b) of FIG. 11 and FIG. 12. As shown in FIG. 12, the guide grooves 300-1a and 300-2a may be formed inward on the weights 300-1 and 300-2, and they may be extended in the longitudinal directions of the weights 300-1 and 300-2, as shown in (b) of FIG. 11. Sliders 710 and 720 at both ends of the coupling ring 700 are inserted in the guide grooves 300-1a and 300-2a, so the coupling ring 700 can slide. One coupling ring 700 or a pair of coupling rings 700 may be provided and they may be disposed at different positions on the weights 300-1 and 300-2. Accordingly, it is possible to more easily balance the different screens 200-1 and 200-2.

That is, by sliding the coupling ring 700 along the guide grooves 300-1a and 300-2a, it is possible to change the connection point between the weights 300-1 and 300-2 and change the position where tension is applied through the coupling ring 700. Accordingly, it is possible to uniformly adjust tension between the screens 200-1 and 200-2 connected to the weights 300-1 and 300-2, respectively. For example, by symmetrically positioning a pair of coupling rings 700 by sliding them to both ends of the weights 300-1 and 30-2, as shown in (b) of FIG. 11, it is possible to uniformly adjust the tension between the screens 200-1 and 200-2.

Accordingly, it is possible to very conveniently and uniformly adjust the lengths of the screens 200-1 and 200-2. When a user adjusts the lengths of the screens 200-1 and 200-2, as shown in (a) and (b) of FIG. 12, by uniformly distributing and transmitting tension through the coupling ring 700 between the weights 300-1 and 300-2, he/she can uniformly move the weights 300-1 and 300-2 only by touching any one of the weights 300-1 and 300-2. If necessary, it is possible to appropriately adjust the thickness and length of the coupling ring 700, and particularly, it is possible to change relative positions of the weights 300-1 and 300-2 by changing the length of the coupling ring 700. Accordingly, it is possible to freely change the overlapping amount of the screens 200-1 and 200-2.

When the coupling ring 700 is formed in this way, the friction stopper assemblies 500-1 and 500-2 may be formed on at least one of the rolls 100-1 and 100-2. Although a plurality of friction stopper assemblies 500-1 and 500-2 is formed on the plurality of rolls 100-1 and 100-2 in the drawings (see FIGS. 13 and 14), a friction stopper assembly may be formed on only one of the rolls 100-1 and 100-2, if necessary. That is, since the weights 300-1 and 300-2 and the screens 200-1 and 200-2 are connected and tension is transmitted through the coupling ring 700, the friction acting on any one of the rolls 100-1 and 100-2 can also be easily transmitted to the other rolls 100-1 and 100-2 due to a change in tension. Accordingly, it is possible to easily operate the blind apparatus 1-1 even without forming a friction stopper assembly on all the plurality of rolls 100-1 and 100-2. The number of the friction stopper assemblies 500-1 and 500-2 can be appropriately changed and the friction force that is generated by the friction stopper assemblies 500-1 and 500-2 can also be appropriately increased or decreased in consideration of the number of the rolls 100-1 and 100-2.

The blind apparatus 1-1 having this configuration according to another embodiment of the present invention can also be very easily operated even without a cord, similar to the blind apparatus described above. That is, as shown in FIGS. 13 and 14, it is possible to easily break the balance and adjust the length of the screens 200-1 and 200-2 by applying a minimum external force to the blind apparatus 1-1 (by simply touching the screen or the weight), using the torques T1 and T2 that are increased or decreased and applied in opposite directions, depending on the unwound length of the screens 200-1 and 200-2. Further, it is possible to maintain the screens 200-1 and 200-2 at the length by returning to the balanced state by removing the external force. Even if subtle unbalance is generated between the torques T1 and T2, the resultant force of the opposite torques T1 and T2 is offset by friction forces, so the stopped state can be more easily maintained. Accordingly, it is possible to obtain a remarkably improved and convenient use environment using the bind apparatus 1-1 of the present invention.

A blind apparatus according to another embodiment of the present invention is described hereafter in detail with reference to FIGS. 15 and 16.

A blind apparatus 1-2 according to another embodiment of the present invention is substantially the same as other embodiments except that a plurality of weights 300-1 and 300-2 are combined by magnetic force. Accordingly, differences from the previous embodiment are described and description of the other components is substituted with the above description.

FIG. 15 is a perspective view of a blind apparatus according to another embodiment of the present invention and FIG. 16 is a side view of the blind apparatus shown in FIG. 15.

Referring to FIG. 15, in the blind apparatus 1-2 according to another embodiment of the present invention, a plurality of weights 300-1 and 300-2 can be attached and fixed to each other by magnetic force. In detail, the blind apparatus 1-2 according to another embodiment of the present invention includes a plurality of rolls respectively coupled to rotary shafts that are parallel to each other, a plurality of screens wound on or unwound from the rolls, respectively, and a plurality of weights 300-1 and 300-2 respectively connected to the lower ends of the screens and applying torque in a first direction in which the screens are unwound to the rolls using gravity, in which the weights 300-1 and 300-2 are combined with each other by magnetic force.

Accordingly, as shown in (a) of FIG. 15, the weights 300-1 and 300-2 can be easily fixed in contact with each other by exchanging magnetic force. Further, as shown in (b) of FIG. 15, the weights 300-1 and 300-2 may be separated and individually operated at positions out of the effective magnetic force exchange range. Accordingly, a plurality of screens can be very conveniently folded or unfolded separately or simultaneously.

In detail, the weights 300-1 and 300-2 may include magnets 300-1c and 300-2c extending in parallel with each other along the lower ends of the screens 200-1 and 200-2 and arranged such that different poles face each other. The magnets 300-1c and 300-2c may be formed in square block shapes and may be arranged such that different poles face each other in order that the N-poles and S-poles of the magnets 300-1c and 300-2c exchange attraction with each other.

The magnets 300-1c and 300-2c may be disposed at both ends of the weights 300-1 and 300-2. As shown in (b) of FIG. 15, the magnets 300-1c and 300-2c may be fixed in end caps 300-1b and 300-2b formed at both ends of the weights 300-1 and 300-2. The contact surfaces between the weights 300-1 and 300-2 may be flat surfaces, as shown in FIG. 16, and at least one of the magnets 300-1c and 300-2c may be disposed on the flat surfaces. Accordingly, as shown in (a) and (b) of FIG. 16, it is possible to more easily exchange magnetic force between the flat surfaces and bring the weights 300-1 and 300-2 in close contact with each other.

The shape or arrangement of the magnets 300-1c and 300-2c may be freely changed in different ways from the embodiment shown in the figures. For example, magnets may be formed extending in the longitudinal direction of the weights 300-1 and 300-2 along the flat surfaces of the weights 300-1 and 300-2. Further, the magnets do not necessarily have to be disposed inside the weights 300-1 and 300-2, and they may be disposed on the outer sides of the weights 300-1 and 300-2, if necessary. The number of magnet disposed on one weight may also be changed in various ways, for example, one or, two or more.

The blind apparatus 1-2 including the magnets 300-1c and 300-2c is not limited to a cordless blind apparatus as in the embodiments of the present invention. That is, the magnets 300-1c and 300-2c of the present invention may be applied and detachably combined with each other in various blind apparatuses including a plurality of weights. According to this structure, it is possible to very conveniently operate a blind apparatus.

Although exemplary embodiments of the present invention were described above with reference to the accompanying drawings, those skilled in the art would understand that the present invention may be implemented in various ways without changing the necessary features or the spirit of the prevent invention. Therefore, the embodiments described above are only examples and should not be construed as being limitative in all respects.

### REFERENCE SIGNS LIST

1, 1-1: Blind apparatus
100, 100-1, 100-2: Roll
101: Guide rail
110, 110-1, 110-2: First rotary shaft
110a, 120a: Rotary ring
110b, 120b: Fixing portion
111, 511: Thread
112: Long groove
113, 522: Fixing projection
114: Stopper
120, 120-1, 120-2: Second rotary shaft
200, 200-1, 200-2: Screen
300, 300-1, 300-2: Weight
300-1a, 300-2a: Guide groove
300-1b, 300-2b: End cap
300-1c, 300-2c: Magnet
400, 400-1, 400-2: Elastic member
410, 410-1, 410-2: Second rotary block
412, 512: Holder
500: Friction stopper assembly
510, 510-1, 510-2: First rotary block
501: Hole
520, 520-1, 520-2: Friction member
521: Serration
610, 620: Fixing bracket
700: Coupling ring
710, 720: Slider
T1: First-directional torque
T2: Second-directional torque

### INDUSTRIAL APPLICABILITY

The present invention relates to a blind apparatus that can be very conveniently operated. It is possible to very easily adjust the length of a screen by winding or unwinding it even without a cord and it is also possible to stably maintain the adjusted length, and thus the blind apparatus has high industrial applicability. According to the blind apparatus of the present invention, it is possible to effectively solve the problem that a blind apparatus is unbalanced or the joint of a cord is broken due to repeated use. Further, it is possible to improve the aesthetic appearance of a blind apparatus by simplifying the external appearance of the blind apparatus, and it is also possible to prevent a safety accident that a person trips on a long cord. Therefore, the blind apparatus can provide various effects and has high industrial applicability.

1. A blind apparatus comprising:
a plurality of rolls respectively coupled to rotary shafts that are parallel with each other;
a plurality of screens respectively wound on or unwound from the rolls; and
a plurality of weights respectively connected to the lower ends of the screens and applying torque in a first direction in which the screens are unwound to the rolls using gravity,
wherein the weights are combined with each other by magnetic force.

2. The blind apparatus of claim 1, further comprising:
a plurality of elastic members applying torque in a second direction in which the screens are wound, by respectively applying elasticity to the rolls; and
a friction stopper assembly generating friction force on the rolls.

3. The blind apparatus of claim 2, wherein the friction force offsets the resultant force of the torque applied to the rolls in the first direction and the torque applied to the rolls in the second direction.

4. The blind apparatus of claim 2, wherein the rotary shafts include a first rotary shaft extending in the rolls, and
the friction stopper assembly includes a first rotary block coupled to the rolls to rotate with the rolls and generating friction on the first rotary shaft.

5. The blind apparatus of claim 4, wherein the first rotary shaft has threads on the outer side to be a male screw, and
the first rotary block has female threads on the inner side of a hole formed through the center thereof to be a female screw that is thread-fastened to the screw.

6. The blind apparatus of claim 4, further comprising a friction member that is disposed on at least one of the outer side of the first rotary shaft and the inner side of the first rotary block to increase friction resistance.

7. The blind apparatus of claim 6, wherein the friction member extends in the longitudinal direction of the first rotary shaft on the outer side of the first rotary shaft.

8. The blind apparatus of claim 1, wherein the weights include magnets extending in parallel with each other along the lower ends of the screens and arranged such that different poles face each other.

9. The blind apparatus of claim 8, wherein the magnets are disposed at both ends of the weights.

10. The blind apparatus of claim 8, wherein the contact surfaces of the weights are flat surfaces.

11. The blind apparatus of claim 10, wherein at least one of the magnets is disposed on the flat surface.

12. The blind apparatus of claim 5, further comprising a friction member that is disposed on at least one of the outer side of the first rotary shaft and the inner side of the first rotary block to increase friction resistance.
